(19) United States
(12) Patent Application Publication
(10) Pub. No.: US 2014/0060197 A1
(43) Pub. Date: Mar. 6, 2014

(54) ULTRASONIC ARRAY TRANSDUCER HOLDER AND GUIDE FOR FLANGES HAVING CUTOUTS AND ASYMMETRIC GEOMETRY

(71) Applicants: Patrick L. Anderson, Sammamish, WA (US); Barry A. Fetzer, Renton, WA (US)

(72) Inventors: Patrick L. Anderson, Sammamish, WA (US); Barry A. Fetzer, Renton, WA (US)

(73) Assignee: THE BOEING COMPANY, Chicago, IL (US)

(21) Appl. No.: 13/601,612

(22) Filed: Aug. 31, 2012

(51) Int. Cl. G01N 29/26

(52) U.S. Cl. 73/634

(57) ABSTRACT

An ultrasonic inspection device employs a transducer incorporating an ultrasonic array and a positioner/holder having abase with a rail extending from the base to support the transducer in at least two lateral positions. A guide extends from the base for contact with a web of a composite shape, the guide maintaining the rail substantially perpendicular to the web. An encoder supported by the base and contacts a flange of the composite shape. The Positioner/holder is adapted for longitudinal motion along the composite shape to create C-scans with the transducer.

### BACKGROUND INFORMATION

1. Field

Embodiments of the disclosure relate generally to the field of ultrasonic testing systems and more particularly to a manipulable holder for an ultrasonic array to accommodate scanning with the array on composite elements such as T-chords having flanges with cutouts and asymmetric geometry.

2. Background

Ultrasonic scanning of composite parts is a key quality control capability. Imaging of surfaces is best conducted with scans along the surface in a substantially linear fashion. Where the ultrasonic array is not as wide as the surface to be scanned, multiple passes along the surface are required. Recording of accurate position information of the array during the scan is critical to obtain desired data coverage. The complexity of many composite parts makes alignment of the array in multiple scans challenging. With parts such as T-chords, the cap flange is likely to be asymmetric and typically has cutouts to accommodate mating components or required pass-throughs. Previous solutions have used the edge of the part being scanned to position the transducer with wide bases that span the largest cut out on the part. In the case of the composite T-Chords, employing the edge of the part and using these design features would force the transducer to rotate at various angles as the transducer scans down the length of the part. When using a rotary encoder that tracks the linear position along the scan, these non-normal angles of the transducer to the scan direction lead to positional errors in the ultrasonic data shown in the C Scan.

It is therefore desirable to provide a holder and guide for ultrasonic transducer arrays which provides accurate scanning placement for the array and further provides accurate position data for correlation of images taken during scanning.

### SUMMARY

Embodiments disclosed herein provide an ultrasonic inspection device which employs a transducer incorporating an ultrasonic array and a positioner/holder having a base with a rail extending from the base to support the transducer in at least two lateral positions. A guide extends from the base for contact with a web of a composite shape, the guide maintaining the rail substantially perpendicular to the web. An encoder is supported by the base and contacts a flange of the composite shape, The positioner/holder is adapted for longitudinal motion along the composite shape to create C-scans with the transducer.

The features, functions, and advantages that have been discussed can be achieved independently in various embodiments of the present disclosure or may be combined in yet other embodiments further details of which can be seen with reference to the following description and drawings.

### BRIEF DESCRIPTION OF THE DRAWINGS

FIG. 1A is a top view of an exemplary T-chord on which the embodiments disclosed herein may be employed;

FIG. 1B is a side section view of the T-chord of FIG. 1A;

FIG. 2 is a front view of an example embodiment engaged to a T-chord with the transducer array in a first scan position;

FIG. 3 is a top view of the embodiment;

FIG. 4 is a front view of the embodiment with the transducer array in a second scan position;

FIG. 5 is a top view of the embodiment with the transducer array in the second scan position;

FIG. 6 is a lower isometric view of the embodiment with the T-chord removed;

FIG. 7 is a bottom view of the embodiment with the T-chord removed;

FIG. 8 is a detailed, view of the position encoder assembly; and,

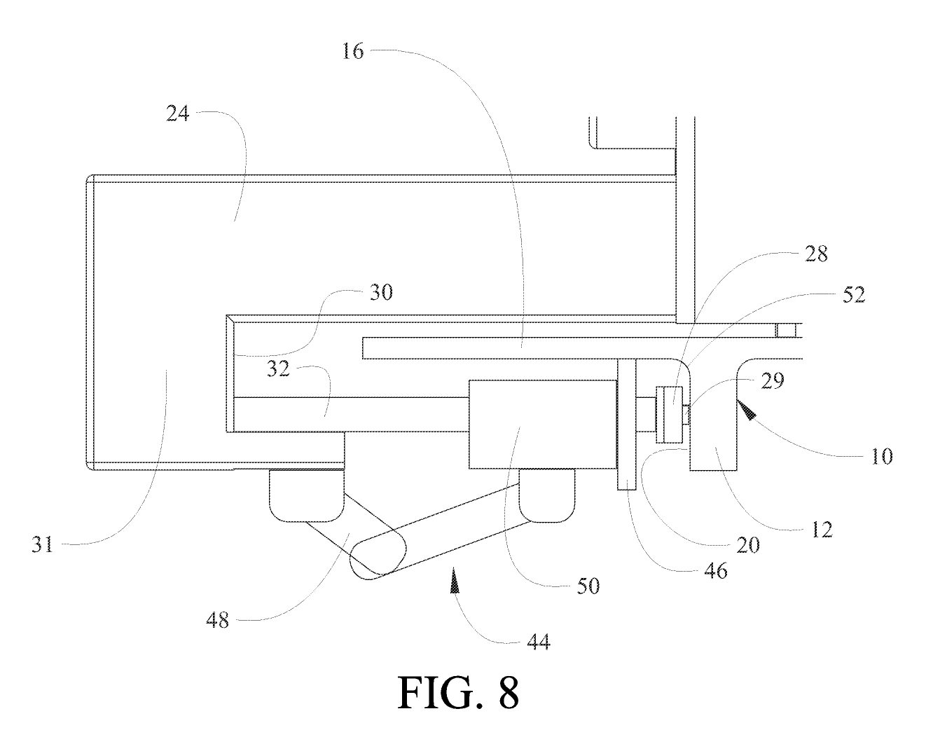

FIG. 9 is a flow chart showing operation of the embodiment for a C-scan of a T-chord.

### DETAILED DESCRIPTION

Embodiments disclosed herein provide a transducer incorporating an ultrasonic array and a positioner/holder having abase with a rail extending from the base to support the transducer in at least two lateral positions. A guide extends from the base for contact with a web of a composite shape. The guide maintains the rail substantially perpendicular to the web. An encoder is supported by the base and contacts a flange of the composite shape. The positioner/holder is adapted for longitudinal motion along the composite shape to create C-scans with the transducer without being impacted by asymmetric or irregular flange shapes or cutouts.

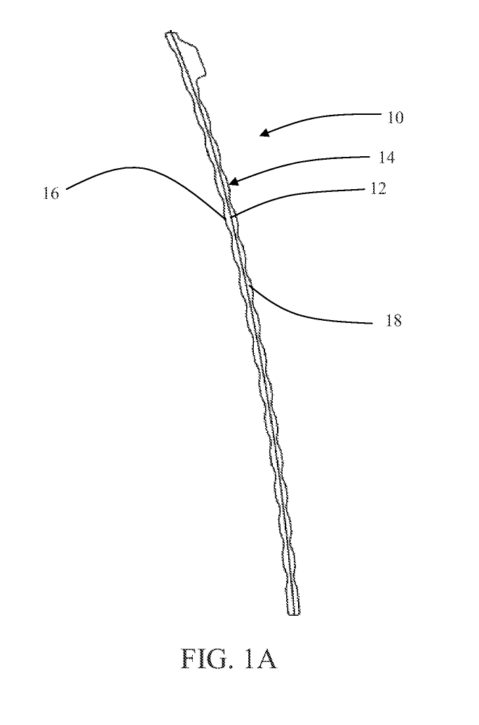

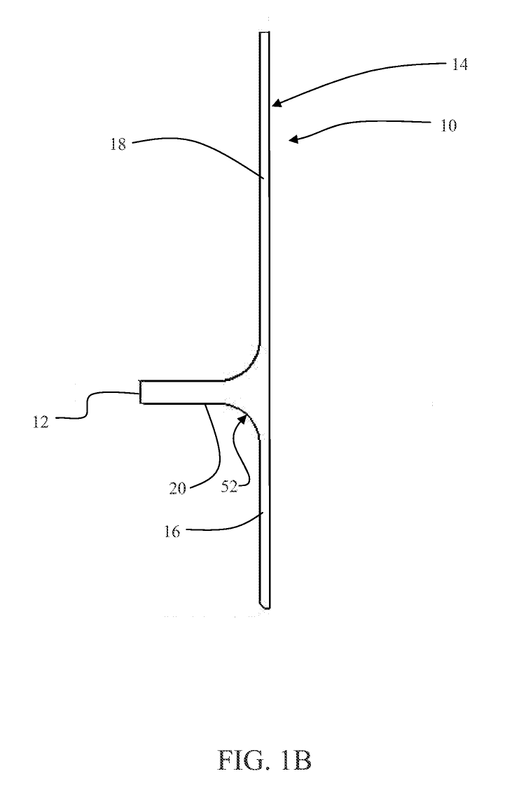

An example composite part on which the present embodiments may be employed is a T-chord 10 shown in FIGS. 1A and 1B. The T-chord has a web 12 and a cap 14 having an inner flange 16 and outer flange 18. A datum in the design of T-chords is a surface 20 of the web 12.

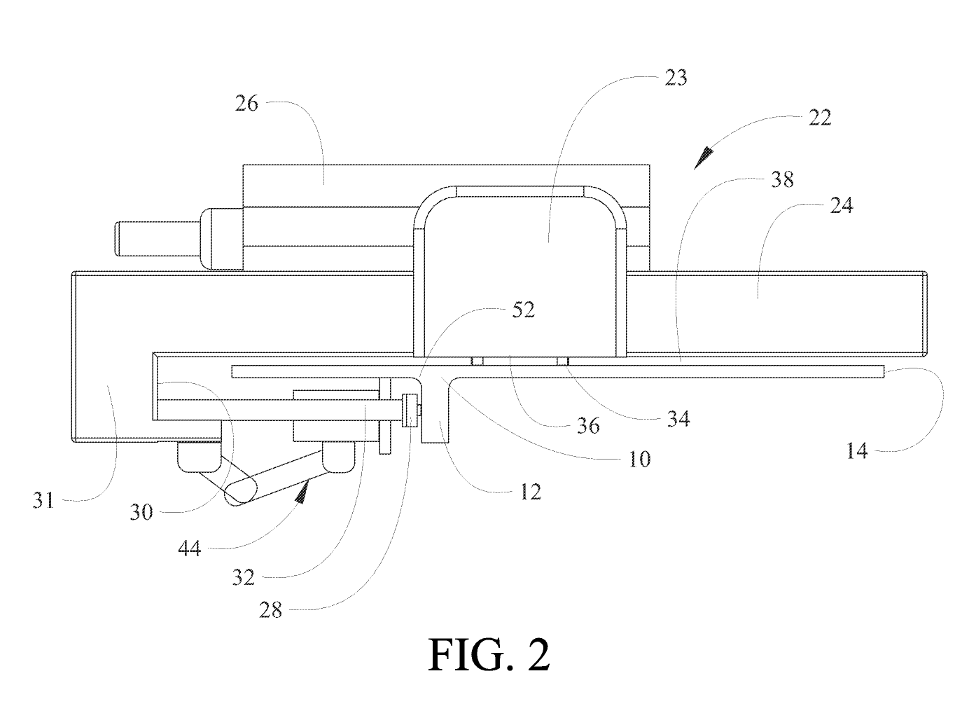

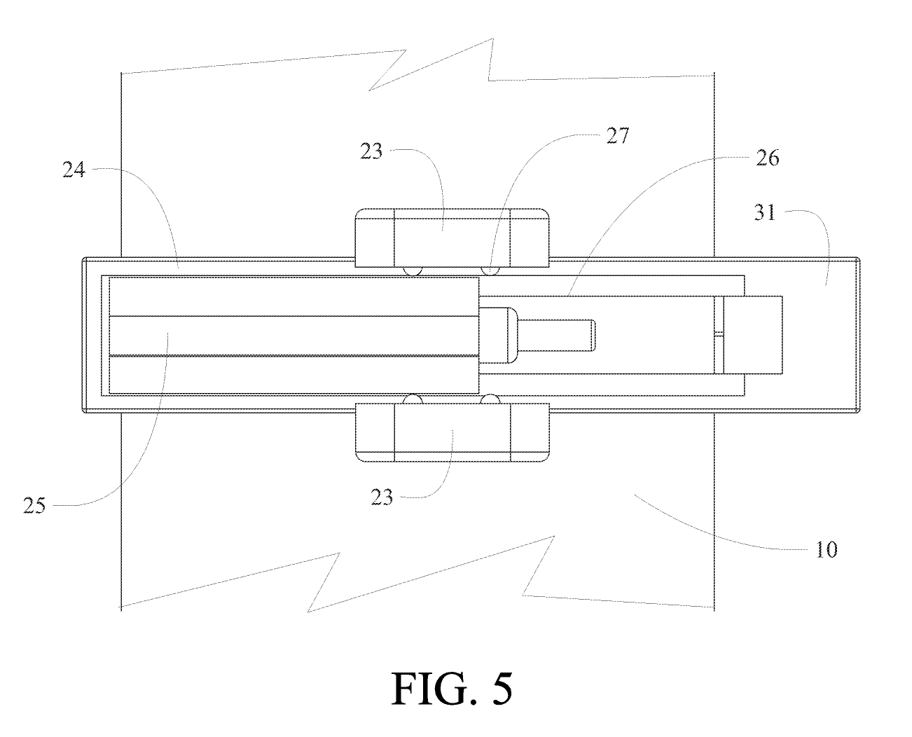

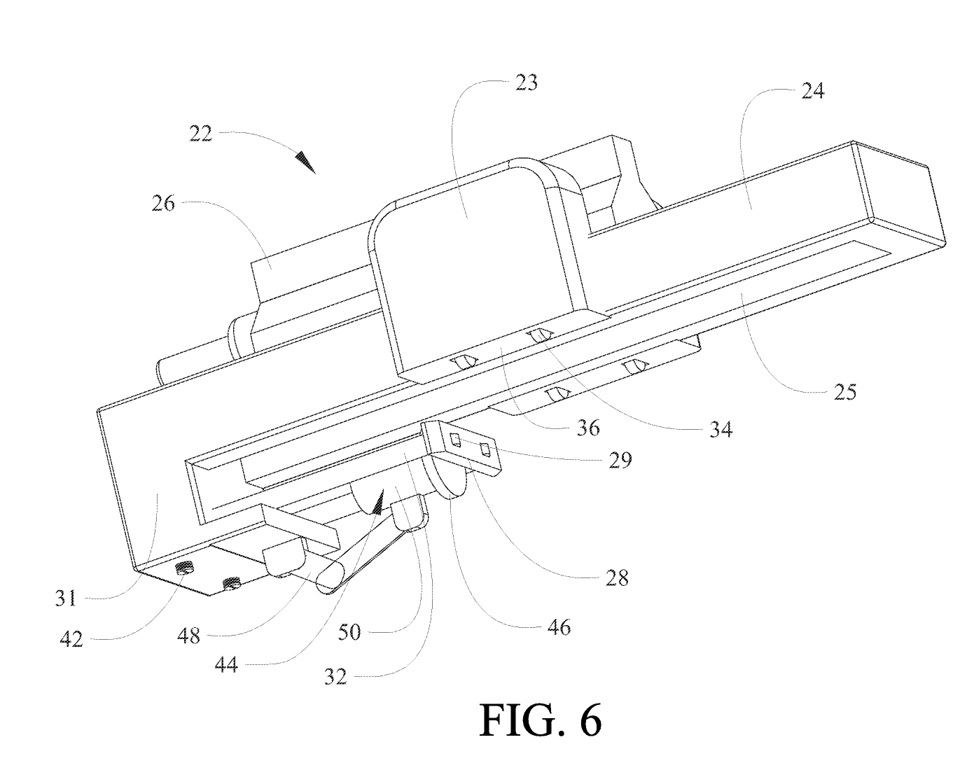

An example embodiment of a transducer positioner/holder 22 as shown FIGS. 2 through 7 employs a support rail 24 for a transducer 26 housing an ultrasonic array, such as a 3.5L 128-NW3 linear transducer from Olympus 48 Woerd Ave, Waltham, Mass. 02453, to obtain C-scan data. A guide 28 which rides on the surface 20 of the web 12 is used to position a near edge 30 of a base 31 of the transducer positioner/holder 22 a set distance laterally from the web. The positioner/holder 22 holds the transducer 26 normal to the web as the transducer positioner/holder is scanned longitudinally along the part. The guide 28 extends from the near edge 30 mounted on positioning rods 32 extending from the base 31. The guide 28 is dimensioned longitudinally (along the web) with sufficient length to provide stable perpendicularity of the support rail 24 relative to the web during the longitudinal scan. Wheels 29 or similar bearing elements extending from the guide 28 (best seen in FIG. 6) provide low friction engagement on surface 20 of the web 12. Positioning the transducer 26 to be normal to the scan direction avoids positional errors in the ultrasonic data that may lead to indications being hidden or incorrectly sized in the C-scan presentation.

The ultrasonic array transducer 26 is adjustable on the support rail 24 for placement at different lateral positions along the length of the positioner/holder 22. Set screws, spring loaded detents or similar locking mechanisms may be employed to secure the transducer in position on the rail. In the embodiment in the drawings, an aperture 25 in the support rail provides a clear field for the acoustic array to interrogate the composite part being scanned. Support piers 23 extend from the support rail 24 substantially opposite the web of the T-chord being measured. The support piers may be movable with respect to the support rail for adjustment with respect to web location for differing T-chord profiles. In alternative embodiments, high friction rollers 27 or similar devices in the support piers may be employed to resistively secure the transducer against unwanted lateral motion yet allow desired positioning. The length of the positioner/holder allows the user to position the array in selected set positions, as exemplified by the transducer positions in FIGS. 2 and 3 and FIGS. 4 and 5 respectively, that are designed to ensure overlap between scans so that there is no missing data. This feature is analogous to the use of overlapping scans with a mechanical x-y gantry system.

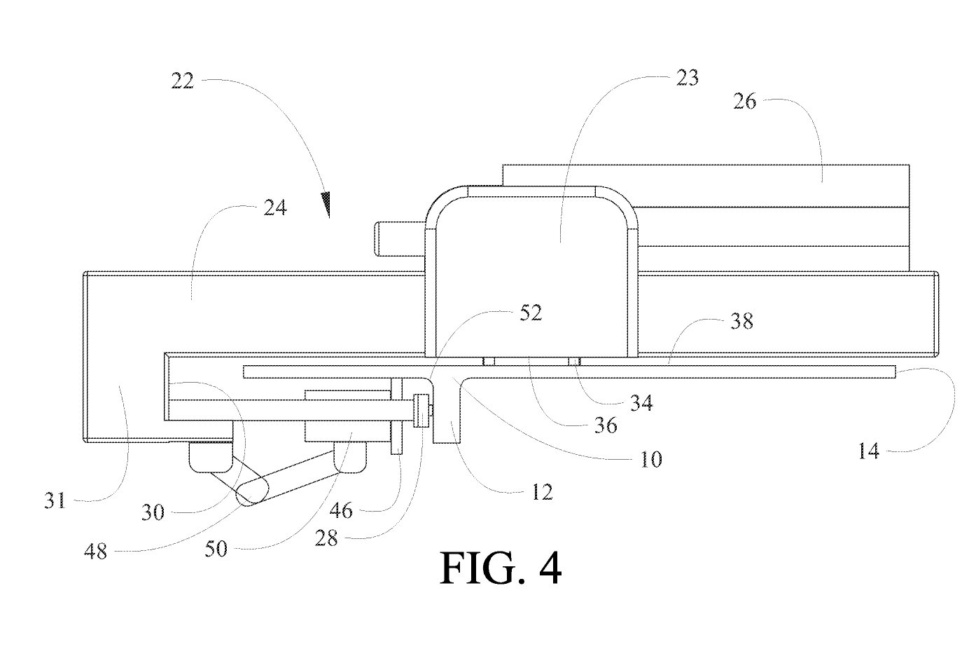

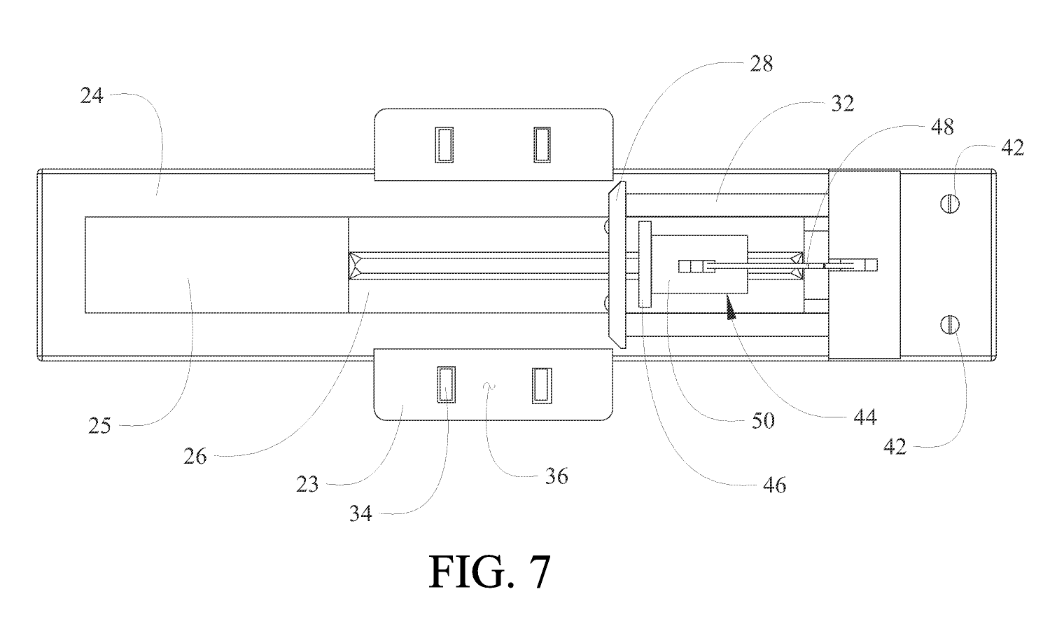

Scanning is accomplished by translation of the positioner/holder 22 longitudinally along the T-chord, Rollers 34 on a lower surface 36 of the support piers 23 extending from the support rail 24 (seen best in FIG. 7) provide low friction engagement of a top surface 38 of the T-chord (seen in FIGS. 2 and 4). Bearings or rollers may alternatively be contained in the bottom surface of the support rail 24. Positioning rods 32 for the guide 28 are telescopically adjustable through bores 40 in the base 31. Set screws 42 (best seen in FIGS. 6 and 70 are employed to lock the positioning rods at the desired extension.

A rotary encoder assembly 44 flexibly extends from the base 31 to be positioned with an encoder wheel 46 on the inner flange 16 of the T-chord 10. A flexing scissor bracket 48 connects an encoder 50 such as an Olympus Mini-Wheel Encoder, to the base 31 for lateral positioning of the encoder wheel 46 adjacent any radius 52 between the web 12 and inner flange 16 and to resiliently urge the encoder wheel into engagement with the inner flange.

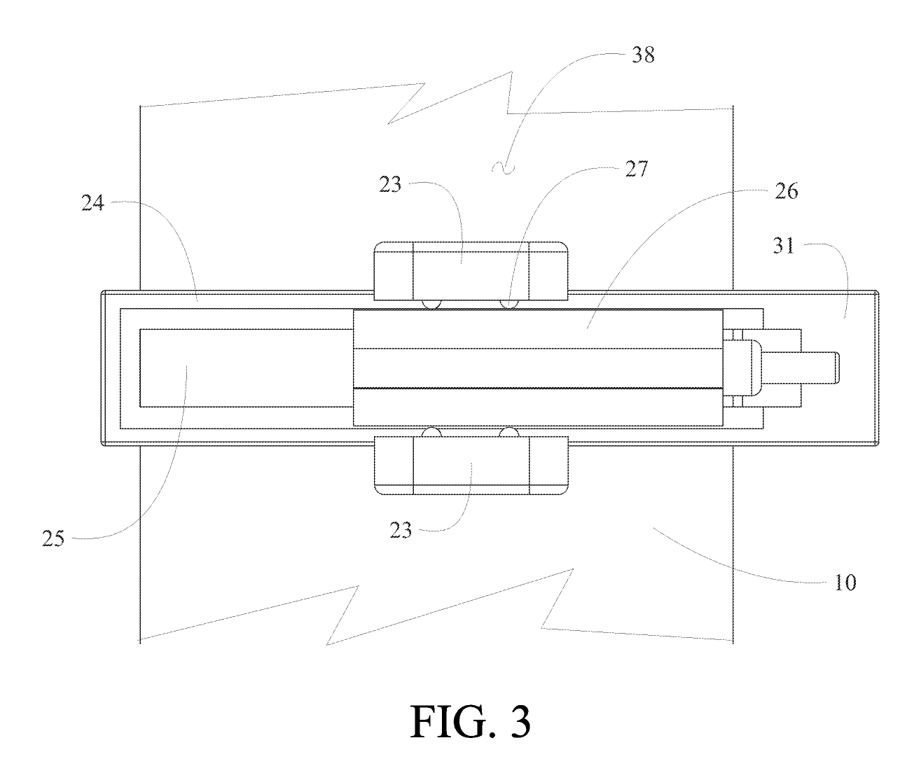

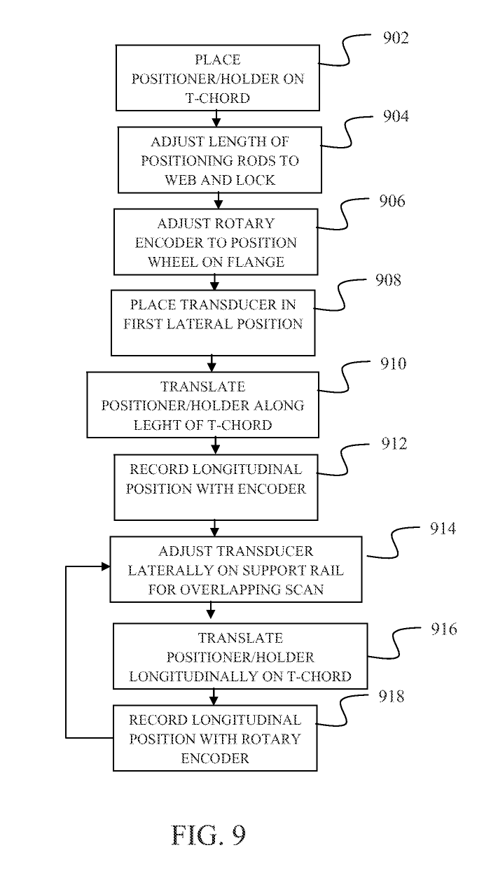

FIG. 9 describes the method employed for implementing measurements using the embodiment as described. In operation, positioner/holder 22 is placed on the top surface 38 of the T-chord, step 902. Positioning rods 32 are adjusted in length from the near edge 30 to place the guide 28 against the surface 20 of the web 12 with clearance for the inner flange 16 for the longitudinal scan and. locked in place using set screws 42, step 904. The rotary encoder assembly 44 is adjusted using flexing scissor bracket 48 to position the encoder wheel 46 on the inner flange 16 adjacent the radius 52 from the web to the inner flange, step 906. The transducer 26 is positioned at a first position on the support rail 24 (as shown in FIGS. 2 and 3) for a first longitudinal scan, step 908. The positioner/holder 22 is then translated along the length of the T-chord, step 910, Longitudinal position of the positioner/holder 22 during the scan is recorded by the rotary encoder 50 for correlation of the data provided by the ultrasonic array in the transducer, step 912, The transducer 26 is then adjusted laterally on the support rail 24 for an overlapping scan, step 914, The positioner/holder 22 is again translated along the length of the T-chord, step 916, and the longitudinal position of the positioner/holder 22 during the scan is recorded by the rotary encoder 50 for correlation of the data provided by the ultrasonic array in the transducer. Steps 914, 916 and 918 may be repeated multiple times for wide flange sizes or overlapped scans as desired.

Having now described various embodiments of the disclosure in detail as required by the patent statutes, those skilled in the art will recognize modifications and substitutions to the specific embodiments disclosed herein. Such modifications are within the scope and intent of the present disclosure as defined in the following claims.

What is claimed is:

1. An ultrasonic inspection device comprising:
a transducer incorporating an ultrasonic array;
a positioner/holder having
a base;
a rail extending from the base to support the transducer in at least two lateral positions;
a guide extending from the base for contact with a web of a composite shape, said guide maintaining the rail substantially perpendicular to the web;
an encoder supported by the base and contacting a flange of the composite shape;
said positioner/holder adapted for longitudinal motion along the composite shape.

2. The ultrasonic inspection device as define(in claim I wherein the guide is supported from the base by at least one adjustable rod.

3. The ultrasonic inspection device as defined in claim 1 wherein the encoder employs an encoder wheel riding on a lower surface of the flange.

4. The ultrasonic inspection device as defined in claim 3 wherein the encoder is connected to the base with an adjustable scissor, said scissor positioning the encoder wheel adjacent the web clear of a radius.

5. The ultrasonic inspection device as defined in claim I wherein the composite shape includes a cap on the web and further comprising pier supports extending from the rail and incorporating wheels riding on and aligned longitudinally with the top surface of the cap.

6. The ultrasonic inspection device as defined in claim 5 wherein the support piers are movable with respect to the rail to be positioned substantially opposite the web.

7. A positioner/holder for an ultrasonic transducer comprising:
a base;
a rail extending from the base to support a transducer in at least two lateral positions;
a guide extending from the base for contact with a web of a composite shape, said guide maintaining the rail substantially perpendicular to the web;
an encoder supported by the base and contacting a flange of the composite shape;
said positioner/holder adapted for longitudinal motion along the composite shape.

8. The positioner/holder for an ultrasonic transducer as defined in claim 7 wherein the guide is supported from the base by at least one adjustable rod.

9. The positioner/holder for an ultrasonic transducer as defined in claim 7 wherein the encoder employs an encoder wheel riding on a lower surface of the flange.

10. The positioner/holder for an ultrasonic transducer as defined in claim 9 wherein the encoder is connected to the base with an adjustable scissor, said scissor positioning the encoder wheel adjacent the web clear of a radius.

11. The positioner/holder for an ultrasonic transducer as defined in claim 7 wherein the composite shape includes a cap on the web and further comprising pier supports extending from the rail and incorporating wheels riding on and aligned longitudinally with the top surface of the cap.

12. The positioner/holder for an ultrasonic transducer as defined in claim 11 wherein the support piers are movable with respect to the rail to be positioned substantially opposite the web,

13. A method for ultrasonic inspection of a T-chord comprising:
mounting an ultrasonic transducer on a rail of a positioner holder;
positioning the positioner/holder with a guide from a web on the T-chord;
translating the positioner holder longitudinally along the T-chord with the ultrasonic transducer in a first lateral position on the rail;
encoding the longitudinal position of the positioner/holder with an encoding wheel engaging a flange of the T-chord;
moving the ultrasonic transducer to a second lateral position on the rail;
repeating the longitudinal translation of the positioner holder along the T-chord; and,
encoding the longitudinal position of the positioner/holder with the encoding wheel during the repeating longitudinal translation.

14. The method of claim 13 further comprising:
moving the ultrasonic transducer to additional lateral positions on the rail; and
repeating the longitudinal translation of the positioner holder along the T-chord; and, encoding the longitudinal position of the positioner/holder with the encoding eel during the repeating longitudinal translation.
